(19) United States
(12) Patent Application Publication
(10) Pub. No.: US 2026/0057572 A1
(43) Pub. Date: Feb. 26, 2026

(54) AUGMENTED REALITY CONTENT TO LOCATE USERS WITHIN A CAMERA USER INTERFACE

(71) Applicant: Snap Inc., Santa Monica, CA (US)

(72) Inventors: Virginia Drummond, Venice, CA (US); Celia Nicole Mourkogiannis, Los Angeles, CA (US); Ibrahem Shekoni, Santa Monica, CA (US)

(21) Appl. No.: 19/376,316

(22) Filed: Oct. 31, 2025

Related U.S. Application Data
(63) Continuation of application No. 17/646,671, filed on Dec. 30, 2021, now Pat. No. 12,469,182.
(60) Provisional application No. 63/133,019, filed on Dec. 31, 2020.

(51) Int. Cl. G06T 11/00; G01C 21/36; G06F 3/04842; H04L 67/52; H04N 23/63

(52) U.S. Cl. CPC G06T 11/00; G01C 21/3647; G06F 3/04842; H04L 67/52; H04N 23/63; G06T 2200/24

(57) ABSTRACT

In one or more implementations, augmented reality content items may be executable to indicate locations of contacts of a user within a camera user interface that is showing content being captured by one or more cameras of a client device. The locations of the contacts may be indicated by representations of the contacts (e.g., avatars) within the camera user interface. The positions of the representations of the contacts within the camera user interface may indicate the locations of the contacts relative to the location of the user of the client device. Navigational tools may also be provided to direct the user of the client device to the location of one or more of the contacts.

### CROSS-REFERENCE TO RELATED APPLICATION

This patent application is a continuation of U.S. patent application Ser. No. 17/646,671, filed Dec. 30, 2021, which application claims the benefit of U.S. Provisional Patent Application No. 63/133,019, filed Dec. 31, 2020, entitled “AUGMENTED REALITY CONTENT TO LOCATE USERS WITHIN A CAMERA USER INTERFACE”, each of which are incorporated by reference herein in their entireties.

### BACKGROUND

Applications executed by client devices may be used to generate content. For example, client applications may be used to generate messaging content, image content, video content, audio content, media overlays, documents, creative works, combinations thereof, and the like. In various situations, user content may be modified by augmented reality content and shared with one or more additional users.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some implementations are illustrated by way of example, and not limitation.

FIG. 1 is a diagrammatic representation of an architecture for exchanging data (e.g., messages and associated content) over a network, according to one or more example implementations.

FIG. 2 is a diagrammatic representation of a system, in accordance with some examples, that may have both client-side and server-side functionality.

FIG. 3 is a schematic diagram illustrating data that may be stored in a database of a server system, according to one or more example implementations.

FIG. 4 is a schematic diagram illustrating an example framework for content that may be accessible via a client application, in accordance with one or more example implementations.

FIG. 5 is a flowchart illustrating example operations of a process to provide augmented reality content to locate users within a camera user interface, in accordance with one or more example implementations.

FIG. 6 is an illustration of a first example user interface showing a view of a camera of a client device and showing relative locations of additional users of a client application within a camera user interface, according to one or more example implementations.

FIG. 7 is an illustration of a second example user interface showing a view of a camera of a client device and showing relative locations of additional users of a client application within a camera user interface, according to one or more example implementations.

FIG. 8 is an illustration of a third example user interface showing a view of a camera of a client device and showing relative locations of additional users of a client application within a camera user interface, according to one or more example implementations.

FIG. 9 is an illustration of a fourth user interface showing a view of a camera of a client device and showing relative locations of additional users of a client application within a camera user interface, according to one or more example implementations.

FIG. 10 is a block diagram illustrating components of a machine, in the form of a computer system, that may read and execute instructions from one or more machine-readable media to perform any one or more methodologies described herein, in accordance with one or more example implementations.

FIG. 11 is block diagram illustrating a representative software architecture that may be used in conjunction with one or more hardware architectures described herein, in accordance with one or more example implementations.

### DETAILED DESCRIPTION

The systems, methods, techniques, instruction sequences, and computing machine program products described herein are directed to providing augmented reality content to locate users within a camera user interface of a client application. In one or more examples, a camera user interface may show a live view captured by one or more cameras of a client device that is operated by a user of the client application. A user interface element displayed within the camera user interface may be selectable to execute an augmented reality content item to locate additional users of the client application within the camera user interface relative to a location of the user of the client device. In various examples, the augmented reality content item may be executable to cause the locations of the additional users of the client application to be displayed in the camera user interface as a representation of the additional users, such as an avatar of the respective additional users. In addition, directions to guide the user of the client device to one or more of the additional user may be displayed within the camera user interface. In one or more illustrative examples, the additional users of the client device may be contacts of the user within the client application, such as “friends” of the user within the client application.

As the location of the user of the client device changes, the locations of the additional users within the camera user interface may also change. Further, the directions provided to the user of the client device may be updated as the position of the user of the client device with respect to the additional users changes. For example, as the user of the client device moves toward or away from one or more of the additional users, the view within the camera user interface may be modified and the directions to locate one or more of the additional users may also be modified. In one or more additional examples, an orientation of the client device may impact the additional users indicated in the camera user interface and may impact the directions to locate the additional users while the geographic position of the user of the client device is unchanged or slightly changed. To illustrate, when the client device is facing a first direction (e.g., southwest), a first group of additional users may be displayed in the camera user interface. In response to the user of the client device turning the client device to point in a different direction (e.g., east), a second group of additional users may be displayed in the camera user interface.

In existing systems, navigation applications typically guide users to a location and are not directed to locating individuals at a given location. The techniques, systems, and methods described herein are directed to guiding users to locations of individuals that are connected within a client application, such as a messaging application or social networking application, rather than simply to a geographic destination.

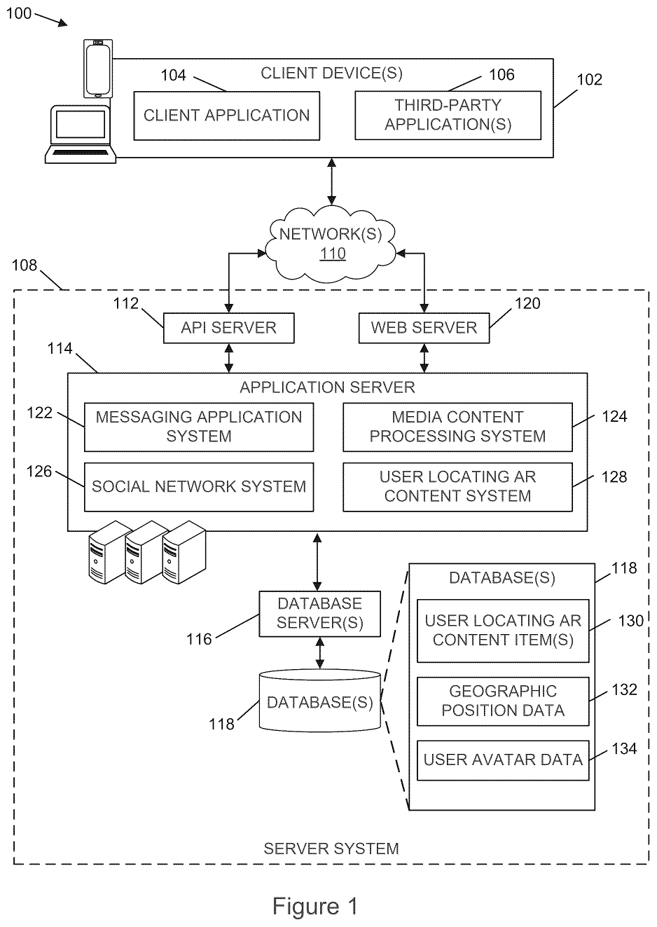

FIG. 1 is a diagrammatic representation of an architecture 100 for exchanging data (e.g., messages and associated content) over a network. The architecture 100 may include multiple client devices 102. The client devices 102 may individually comprise, but are not limited to, a mobile phone, a desktop computer, a laptop computing device, a portable digital assistant (PDA), smart phone, tablet computing device, ultrabook, netbook, multi-processor system, microprocessor-based or programmable consumer electronic system, game console, set-top box, computer in a vehicle, a wearable device, one or more combinations thereof, or any other communication device that a user may utilize to access one or more components included in the architecture 100.

Each client device 102 may host a number of applications, including a client application 104 and one or more third-party applications 106. A user may use the client application 104 to create content, such as video, images (e.g., photographs), audio, and media overlays. In one or more illustrative examples, the client application 104 may include a social networking functionality that enables users to create and exchange content. In various examples, the client application 104 may include messaging functionality that may be used to send messages between instances of the client application 104 executed by various client devices 102. The messages created using the client application 104 may include video, one or more images, audio, media overlays, text, content produced using one or more creative tools, annotations, and the like. In one or more implementations, the client application 104 may be used to view and generate interactive messages, view locations of other users of the client application 104 on a map, chat with other users of the client application 104, and so forth.

One or more users may be a person, a machine, or other means of interacting with a client device, such as the client device 102. In example implementations, the user may not be part of the architecture 100 but may interact with one or more components of the architecture 100 via a client device 102 or other means. In various examples, users may provide input (e.g., touch screen input or alphanumeric input) to a client device 102 and the input may be communicated to other entities in the architecture 100. In this instance, the other entities in the architecture 100, responsive to the user input, may communicate information to a client device 102 to be presented to the users. In this way, users may interact with the various entities in the architecture 100 using the client device 102.

Each instance of the client application 104 is able to communicate and exchange data with at least one of another instance of the client application 104, one or more third-party applications 106, or a server system 108. The data exchanged between instances of the client applications 104, between the third-party applications 106, and between instances of the client application 104 and the server system 108 includes functions (e.g., commands to invoke functions) and payload data (e.g., text, audio, image, video, or other multimedia data). Data exchanged between instances of the client applications 104, between the third-party applications 106, and between at least one instance of the client application 104 and at least one third-party application 106 may be exchanged directly from an instance of an application executed by a client device 102 and an instance of an application executed by an additional client device 102. Further, data exchanged between the client applications 104, between the third-party applications 106, and between at least one client application 104 and at least one third-party application 106 may be communicated indirectly (e.g., via one or more intermediate servers) from an instance of an application executed by a client device 102 to another instance of an application executed by an additional client device 102. In one or more illustrative examples, the one or more intermediate servers used in indirect communications between applications may be included in the server system 108.

The third-party application(s) 106 may be separate and distinct from the client application 104. The third-party application(s) 106 may be downloaded and installed by the client device 102 separately from the client application 104. In various implementations, the third-party application(s) 106 may be downloaded and installed by the client device 102 before or after the client application 104 is downloaded and installed. The third-party application(s) 106 may be an application that is provided by an entity or organization that is different from the entity or organization that provides the client application 104. The third-party application(s) 106 may be accessed by the client device 102 using separate login credentials than the client application 104. Namely, the third-party application(s) 106 may maintain a first user account and the client application 104 may maintain a second user account. In one or more implementations, the third-party application(s) 106 may be accessed by the client device 102 to perform various activities and interactions, such as listening to music, videos, track exercises, view graphical elements (e.g., stickers), communicate with other users, and so forth. As an example, the third-party application(s) 106 may include a social networking application, a dating application, a ride or car sharing application, a shopping application, a trading application, a gaming application, an imaging application, a music application, a video browsing application, an exercise tracking application, a health monitoring application, a graphical element or sticker browsing application, or any other suitable application.

The server system 108 provides server-side functionality via one or more networks 110 to the client application 104. The server system 108 may be a cloud computing environment, according to some example implementations. For example, the server system 108, and one or more servers associated with the server system 108, may be associated with a cloud-based application, in one illustrative example. In one or more implementations, the client device 102 and the server system 108 may be coupled via the one or more networks 110.

The server system 108 supports various services and operations that are provided to the client application 104. Such operations include transmitting data to, receiving data from, and processing data generated by the client application 104. This data may include message content, media content, client device information, geolocation information, media annotation and overlays, message content persistence conditions, social network information, and live event information, as examples. Data exchanges within the architecture 100 are invoked and controlled through functions available via user interfaces (UIs) of the client application 104.

While certain functions of the architecture 100 are described herein as being performed by either a client application 104 or by the server system 108, the location of functionality either within the client application 104 or the server system 108 is a design choice. For example, it may be technically preferable to initially deploy certain technology and functionality within the server system 108, but to later migrate this technology and functionality to the client application 104 where a client device 102 has a sufficient processing capacity.

The server system 108 includes an Application Programming Interface (API) server 112 that is coupled to, and provides a programmatic interface to, an application server 114. The application server 114 is communicatively coupled to a database server 116 that facilitates access to one or more databases 118. The one or more databases 118 may store data associated with information processed by the application server 114. The one or more databases 118 may be storage devices that store information such as untreated media content, original media content from users (e.g., high-quality media content), processed media content (e.g., media content that is formatted for sharing with client devices 102 and viewing on client devices 102), context data related to a media content item, context data related to a user device (e.g., a computing or client device 102), media overlays, media overlay smart widgets or smart elements, user data, user device information, media content (e.g., video and images), media content data (e.g., data associated with video and images), computing device context data, serialized data, session data items, user device location data, mapping information, interactive message usage data, interactive message metrics data, and so forth. The one or more databases 118 may further store information related to third-party servers, client devices 102, client applications 104, users, third-party applications 106, and so forth.

The API server 112 receives and transmits data (e.g., commands and message payloads) between client devices 102 and the application server 114. Specifically, the Application Program Interface (API) server 112 provides a set of interfaces (e.g., routines and protocols) that can be called or queried by the client application 104 in order to invoke functionality of the application server 114. The Application Program Interface (API) server 112 exposes various functions supported by the application server 114, including account registration, login functionality, the sending of messages, via the application server 114, from one instance of the client application 104 to another instance of the client application 104, the sending of media files (e.g., images, audio, video) from a client application 104 to the application server 114, and for possible access by another client application 104, the setting of a collection of media content (e.g., a gallery, story, message collection, or media collection), the retrieval of a list of friends of a user of a client device 102, the retrieval of such collections, the retrieval of messages and content, the adding and deletion of friends to a social graph, the location of friends within a social graph, and opening an application event (e.g., relating to the client application 104).

The server system 108 may also include a web server 120. The web server 120 is coupled to the application servers 114, and provides web-based interfaces to the application servers 114. To this end, the web server 120 processes incoming network requests over the Hypertext Transfer Protocol (HTTP) and several other related protocols.

The application server 114 hosts a number of applications and subsystems, including a messaging application system 122, a media content processing system 124, a social network system 126, and user location augmented reality (AR) content system 128. The messaging application system 122 implements a number of message processing technologies and functions, particularly related to the aggregation and other processing of content (e.g., textual and multimedia content) included in messages received from multiple instances of the client application 104. For example, the messaging application system 122 may deliver messages using electronic mail (email), instant messaging (IM), Short Message Service (SMS), text, facsimile, or voice (e.g., Voice over IP (VOIP)) messages via wired networks (e.g., the Internet), plain old telephone service (POTS), or wireless networks (e.g., mobile, cellular, WIFI, Long Term Evolution (LTE), or Bluetooth). The messaging application system 122 may aggregate text and media content from multiple sources into collections of content. These collections are then made available, by the messaging application system 122, to the client application 104. Other processor- and memory-intensive processing of data may also be performed server-side by the messaging application system 122, in view of the hardware requirements for such processing.

The media content processing system 124 is dedicated to performing various media content processing operations, typically with respect to images, audio, or video received within the payload of a message or other content item at the messaging application system 122. The media content processing system 124 may access one or more data storages (e.g., the database(s) 118) to retrieve stored data to use in processing media content and to store results of processed media content.

The social network system 126 supports various social networking functions and services, and makes these functions and services available to the messaging application system 122. To this end, the social network system 126 maintains and accesses an entity graph within the database(s) 118. Examples of functions and services supported by the social network system 126 include the identification of other users of the client application 104 with which a particular user has relationships or is “following”, and also the identification of other entities and interests of a particular user. The social network system 126 may access location information associated with each of the user's friends or other social network connections to determine where they live or are currently located geographically. In addition, the social network system 126 may maintain a location profile for each of the user's friends indicating the geographical location where the user's friends live.

The user locating AR content system 128 may generate one or more user locating AR content items 130 that include computer-readable instructions that may be executable to display locations of users of the client application 104 within a camera user interface. The user locating AR content items 130 may also be executable to provide directions to guide a first user of the client application 104 to the respective locations of one or more second users of the client application 104. In various examples, the directions may be visual. For example, the user locating AR content items 130 may cause one or more indicators to be displayed that indicate the location of the one or more second users relative to the location of the first user. The indicators may include at least one of one or more arrows pointing to relative locations of the one or more second users or a compass indicating a direction to move in order to locate one or more of the second users. The directions may also be textual and include words indicating movement of the first user to locate the one or more second users. Additionally, the directions may be audible and provided via a speaker of a client device operated by the first user. In one or more examples, at least one of image content or video content may be displayed within the camera user interface by the user locating AR content items 130 to guide the first user to the location of one or more of the second users of the client application 104.

In various examples, in response to determining that input data has been captured to launch a user locating AR content item 130, the user locating AR content system 128 may determine a location of the first user of the client application based on geographic position data 132 of the first user. In one or more illustrative examples, the geographic position data 132 may include geographic positioning system (GPS) data. The geographic position data 132 may be obtained from a client device 102 of the first user. Additionally, the geographic position data 132 may be obtained from at least one of one or more wide area wireless communication networks or one or more local area networks. In one or more implementations, the geographic position data 132 may also indicate an orientation of the client device 102 of the first user. For example, the geographic position data 132 may indicate a direction that a camera of the client device 102 of the first user is facing.

The user locating AR content system 128 may also analyze geographic position data 132 of second users of the client application 104 that are connected to the first user within the client application 104. Based on the geographic position data 132, the user locating AR content system 128 may determine one or more second users of the client application 104 that are within a geographic region in which the first user is located. In one or more illustrative examples, the geographic region may be within 0.1 miles of the first user, within 0.2 miles of the first user, within 0.5 miles of the first user, within 1 mile of the first user, within 2 miles of the first user, within 5 miles of the first user, within 10 miles of the first user, within 25 miles of the first user, or within 50 miles of the first user. In at least some examples, the geographic region may be within lesser distances or greater distances than those listed above.

Based on the one or more second users within the geographic region of the first user and based on an orientation of the client device 102 of the first user, the user locating AR content system 128 may determine a respective avatar of the one or more second users of the client application 104. Avatars of users of the client application 104 may be stored in the database(s) 118 as user avatar data 134. In situations where an avatar of a second user of the client application 104 is unavailable, the user locating AR content system 128 may determine an image of the second user or an identifier of the second user (e.g., user name, given name) to display within the camera user interface to indicate the location of the second user.

The user avatar data 134 may include data corresponding to one or more avatars of individual users of the client application 104. In one or more examples, the user avatar data 134 may include a number of avatars of a user of the client application 104. The one or more avatars of a user of the client application 104 may be generated using one or more images of the user. In this way, one or more avatars of a user of the client application 104 may be a graphical representation of the user within the client application 104. For example, the avatar of the user may be included in messages generated using the client application 104. In one or more additional examples, the avatar of the user may indicate a location of the user in one or more map user interfaces of the client application 104. Further, the avatar of the user may represent the user within one or more games in which the user participates via the client application 104.

An avatar of a user of the client application 104 may be generated by identifying facial features of the user within one or more images, such as a mouth of the user, eyes of the user, nose of the user, chin of the user, cheeks of the user, face shape, skin tone, hair features (e.g., color, length, type, style), jaw shape, eyebrows, and the like. Regions of an avatar of the user may also be generated that correspond to facial features of the user, such that the avatar of the user resembles the user. Various avatars of a user of the client application 104 may have different facial expressions. In addition, different avatars of the user may wear different articles of clothing and/or different accessories. Further, different avatars of the user may be associated with different poses or different motions. In one or more examples, the user may customize an avatar of the user by selecting one or more templates that may be used with respect to the avatar of the user. The one or more templates may correspond to one or more poses, one or more facial expressions, one or more articles of clothing, one or more objects that the avatar may interact with, and the like.

The user locating AR content system 128 may then determine a relative location of the one or more second users of the client application 104 with respect to the first user of the client application 104. In various examples, the user locating AR content system 128 may determine directions to guide the first user to one or more of the second users within the geographic region of the first user and based on the orientation of the camera of the client device 102 of the first user. In one or more examples, the user locating AR content system 128 may send the avatar data of the one or more second users and the relative positions of the one or more second users to a user locating AR content item 130 being executed on the client device 102 of the first user with respect to the client application 104. The user locating AR content item 130 may then determine a position within the camera user interface to place the respective avatars of the second users to indicate the relative location of the second users with respect to the first user. The user locating AR content item 130 may also output at least one of audio or visual directions to locate one or more of the second users that are represented within the camera user interface. In one or more illustrative examples, the avatars of the one or more second users may be displayed overlaying a scene shown within the camera user interface that is being captured by at least one camera of the client device 102. Directions to locate one or more of the second users may also be displayed overlaying the scene shown within the camera user interface being captured by at least one camera of the client device 102.

As the relative location of one or more second users with respect to the first user changes, the second users represented in the camera user interface as well as the positions of the second users within the camera user interface may be modified. For example, as at least one of the first user or the one or more second users change location, the user locating AR content item 130 may modify the position of the representations of the one or more second users within the camera user interface. In one or more examples, avatars of one or more of the second users may be removed from the camera user interface. In one or more additional examples, avatars of one or more of the second users may be added to the camera user interface. Further, as the relative location of one or more second users with respect to the first user changes, the user locating AR content item 130 may update directions for the first user to locate the one or more second users.

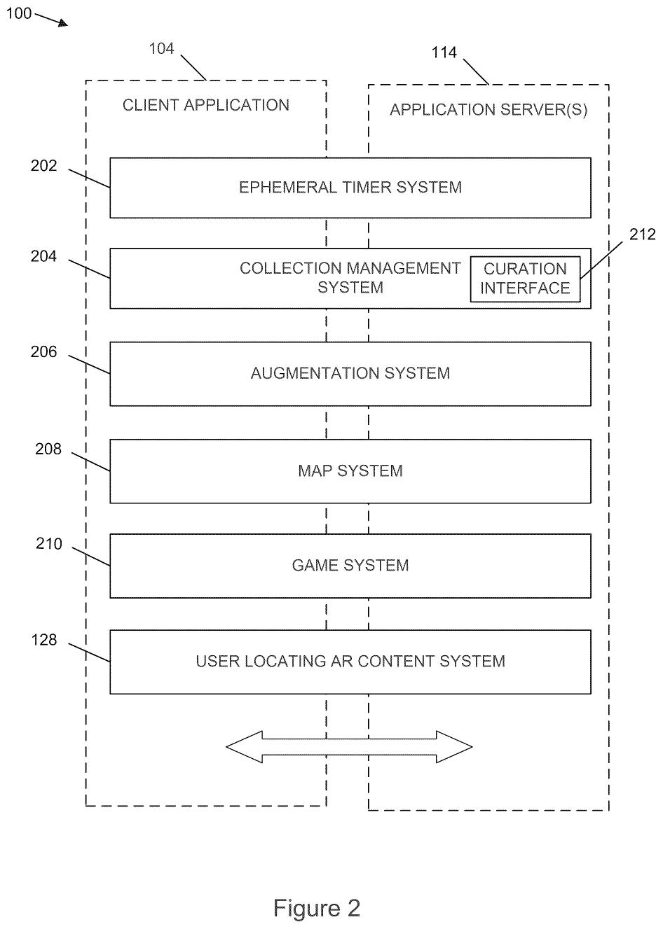

FIG. 2 is a block diagram illustrating further details regarding the server system 108, according to some examples. Specifically, the server system 108 is shown to comprise the client application 104 and the application servers 114. The server system 108 embodies a number of subsystems, which are supported on the client-side by the client application 104 and on the sever-side by the application servers 114. These subsystems include, for example, an ephemeral timer system 202, a collection management system 204, an augmentation system 206, a map system 208, a game system 210, and the user locating AR content system 128.

The ephemeral timer system 202 is responsible for enforcing the temporary or time-limited access to content by the client application 104 and the messaging application system 122. The ephemeral timer system 202 incorporates a number of timers that, based on duration and display parameters associated with a message, or collection of messages (e.g., a story), selectively enable access (e.g., for presentation and display) to messages and associated content via the client application 104. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the client application 104.

The collection management system 204 furthermore includes a curation interface 212 that allows a collection manager to manage and curate a particular collection of content. For example, the curation interface 212 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 206 provides various functions that enable a user to augment (e.g., annotate or otherwise modify or edit) media content associated with content produced via the client application 104, such as a message. For example, the augmentation system 206 provides functions related to the generation and publishing of media overlays for content processed by the server system 108. The augmentation system 206 operatively supplies a media overlay or augmentation (e.g., an image filter) to the client application 104 based on a geolocation of the client device 102. In another example, the augmentation system 206 operatively supplies a media overlay to the client application 104 based on other information, such as social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 102. For example, the media overlay may include text or image that can be overlaid on top of a photograph taken by the client device 102. In another example, the media overlay includes an identification of a location overlay (e.g., Venice beach), a name of a live event, or a name of a merchant overlay (e.g., Beach Coffee House). In another example, the augmentation system 206 uses the geolocation of the client device 102 to identify a media overlay that includes the name of a merchant at the geolocation of the client device 102. The media overlay may include other indicia associated with the merchant. The media overlays may be stored in the database(s) 118 and accessed through the database server(s) 116.

In some examples, the augmentation system 206 provides a user-based publication platform that enables users to select a geolocation on a map and upload content associated with the selected geolocation. The user may also specify circumstances under which a particular media overlay should be offered to other users. The augmentation system 206 generates a media overlay that includes the uploaded content and associates the uploaded content with the selected geolocation.

In other examples, the augmentation system 206 provides a merchant-based publication platform that enables merchants to select a particular media overlay associated with a geolocation via a bidding process. For example, the augmentation system 206 associates the media overlay of the highest bidding merchant with a corresponding geolocation for a predefined amount of time.

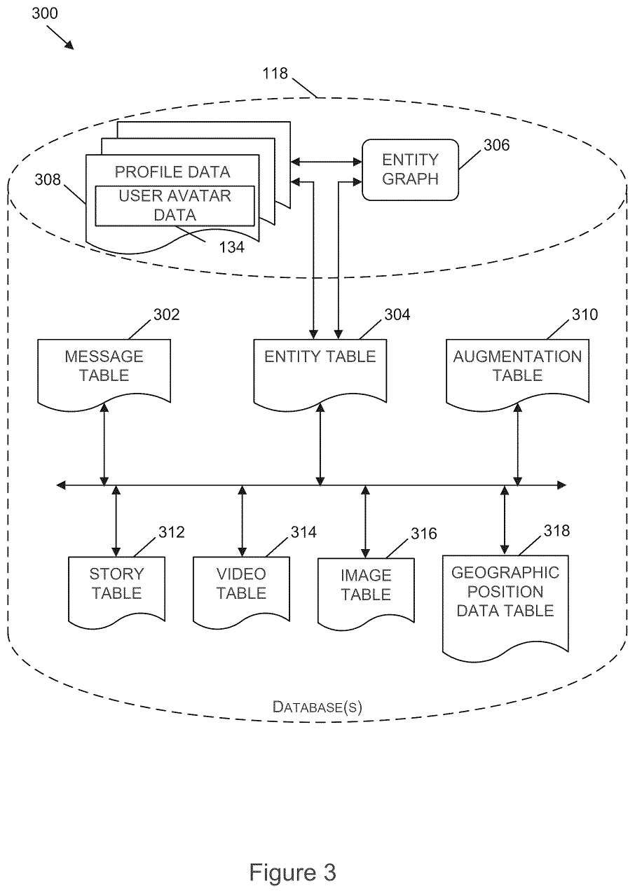

The map system 208 provides various geographic location functions, and supports the presentation of map-based media content and messages by the client application 104. For example, the map system 208 enables the display of user icons or avatars (e.g., stored in profile data 308 of FIG. 3) on a map to indicate a current or past location of “friends” of a user, as well as media content (e.g., collections of messages including photographs and videos) generated by such friends, within the context of a map. For example, a message posted by a user to the server system 108 from a specific geographic location may be displayed within the context of a map at that particular location to “friends” of a specific user on a map interface of the client application 104. A user can furthermore share his or her location and status information (e.g., using an appropriate status avatar) with other users of the server system 108 via the client application 104, with this location and status information being similarly displayed within the context of a map interface of the client application 104 to selected users.

The game system 210 provides various gaming functions within the context of the client application 104. The client application 104 provides a game interface providing a list of available games that can be launched by a user within the context of the client application 104, and played with other users of the server system 108. The server system 108 further enables a particular user to invite other users to participate in the play of a specific game, by issuing invitations to such other users from the client application 104. The client application 104 also supports both the voice and text messaging (e.g., chats) within the context of gameplay, provides a leaderboard for the games, and also supports the provision of in-game rewards (e.g., coins and items).

The user locating AR content system 128 may operate in conjunction with the map system 208 to determine locations of second users of the client application 104 with respect to a first user of the application 104 that is requesting to locate one or more of the second users. Additionally, the user locating AR content system 128 may operate in conjunction with the augmentation system 206 to at least one of generate or execute one or more augmented reality content items that display representations of the one or more second users within a camera user interface of the client application 104 and to display directions to guide the first user to locate one or more of the second users.

FIG. 3 is a schematic diagram illustrating data structures 300 which may be stored in the database(s) 118 of the server system 108, according to one or more example implementations. While the content of the database(s) 118 is shown to comprise a number of tables, it will be appreciated that the data could be stored in other types of data structures (e.g., as an object-oriented database).

The database 118 includes message data stored within a message table 302. This message data includes, for any particular one message, at least message sender data, message recipient (or receiver) data, and a payload.

An entity table 304 stores entity data, and is linked (e.g., referentially) to an entity graph 306 and profile data 308. Entities for which records are maintained within the entity table 304 may include individuals, corporate entities, organizations, objects, places, events, and so forth. Regardless of entity type, any entity regarding which the server system 108 stores data may be a recognized entity. Each entity is provided with a unique identifier, as well as an entity type identifier (not shown).

The entity graph 306 stores information regarding relationships and associations between entities. Such relationships may be social, professional (e.g., work at a common corporation or organization) interested-based or activity-based, merely for example.

The profile data 308 stores multiple types of profile data about a particular entity. The profile data 308 may be selectively used and presented to other users of the architecture 100, based on privacy settings specified by a particular entity. Where the entity is an individual, the profile data 308 includes, for example, a username, telephone number, address, settings (e.g., notification and privacy settings), as well as a user-selected avatar representation (or collection of such avatar representations). Avatars of users of the client application 104 may be stored as user avatar data 134. A particular user may then selectively include one or more of these avatar representations within the content of messages or other data communicated via the architecture 100, and on map interfaces displayed by client application 104 to other users. The collection of avatar representations may include “status avatars,” which present a graphical representation of a status or activity that the user may select to communicate at a particular time.

Where the entity is a group, the profile data 308 for the group may similarly include one or more avatar representations associated with the group, in addition to the group name, members, and various settings (e.g., notifications) for the relevant group.

The database 118 also stores augmentation data, such as overlays or filters, in an augmentation table 310. The augmentation data is associated with and applied to videos (for which data is stored in a video table 314) and images (for which data is stored in an image table 316).

Filters, in one example, are overlays that are displayed as overlaid on an image or video during presentation to a recipient user. Filters may be of various types, including user-selected filters from a set of filters presented to a sending user by the client application 104 when the sending user is composing a message. Other types of filters include geolocation filters (also known as geo-filters), which may be presented to a sending user based on geographic location. For example, geolocation filters specific to a neighborhood or special location may be presented within a user interface by the client application 104, based on geolocation information determined by a Global Positioning System (GPS) unit of the client device 102.

Another type of filter is a data filter, which may be selectively presented to a sending user by the client application 104, based on other inputs or information gathered by the client device 102 during the message creation process. Examples of data filters include current temperature at a specific location, a current speed at which a sending user is traveling, battery life for a client device 102, or the current time.

Other augmentation data that may be stored within the image table 316 includes augmented reality content items (e.g., corresponding to applying Lenses or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of a client device 102 and then displayed on a screen of the client device 102 with the modifications. This also includes modifications to stored content, such as video clips in a gallery that may be modified. For example, in a client device 102 with access to multiple augmented reality content items, a user can use a single video clip with multiple augmented reality content items to see how the different augmented reality content items will modify the stored clip. For example, multiple augmented reality content items that apply different pseudorandom movement models can be applied to the same content by selecting different augmented reality content items for the content. Similarly, real-time video capture may be used with an illustrated modification to show how video images currently being captured by sensors of a client device 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various implementations, different methods for achieving such transformations may be used. Some examples may involve generating a three-dimensional mesh model of the object or objects, and using transformations and animated textures of the model within the video to achieve the transformation. In other examples, tracking of points on an object may be used to place an image or texture (which may be two dimensional or three dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated (e.g., using an Active Shape Model (ASM) or other known methods). Then, a mesh based on the characteristic points is generated for each of the at least one element of the object. This mesh used in the following stage of tracking the elements of the object in the video stream. In the process of tracking, the mentioned mesh for each element is aligned with a position of each element. Then, additional points are generated on the mesh. A first set of first points is generated for each element based on a request for modification, and a set of second points is generated for each element based on the set of first points and the request for modification. Then, the frames of the video stream can be transformed by modifying the elements of the object on the basis of the sets of first and second points and the mesh. In such method, a background of the modified object can be changed or distorted as well by tracking and modifying the background.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing color of areas; removing at least some part of areas from the frames of the video stream; including one or more new objects into areas which are based on a request for modification; and modifying or distorting the elements of an area or object. In various implementations, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image with use of a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some implementations, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

In various examples, a search for landmarks from the mean shape aligned to the position and size of the face determined by a global face detector is started. Such a search then repeats the steps of suggesting a tentative shape by adjusting the locations of shape points by template matching of the image texture around each point and then conforming the tentative shape to a global shape model until convergence occurs. In one or more systems, individual template matches are unreliable, and the shape model pools the results of the weak template matches to form a stronger overall classifier. The entire search is repeated at each level in an image pyramid, from coarse to fine resolution.

A transformation system can capture an image or video stream on a client device (e.g., the client device 102) and perform complex image manipulations locally on the client device 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client device 102.

A computer animation model to transform image data can be used by a system where a user may capture an image or video stream of the user (e.g., a selfie) using a client device 102 having a neural network operating as part of a client application 104 operating on the client device 102. The transformation system operating within the client application 104 determines the presence of a face within the image or video stream and provides modification icons associated with a computer animation model to transform image data, or the computer animation model can be present as associated with an interface described herein. The modification icons include changes that may be the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the client device 102 as soon as the image or video stream is captured, and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various implementations, a modification may be persistent after an initial selection of a modification icon. The user may toggle the modification on or off by tapping or otherwise selecting the face being modified by the transformation system and store it for later viewing or browse to other areas of the imaging application. Where multiple faces are modified by the transformation system, the user may toggle the modification on or off globally by tapping or selecting a single face modified and displayed within a graphical user interface. In some implementations, individual faces, among a group of multiple faces, may be individually modified, or such modifications may be individually toggled by tapping or selecting the individual face or a series of individual faces displayed within the graphical user interface.

A story table 312 stores data regarding collections of messages and associated image, video, or audio data, which are compiled into a collection (e.g., a story or a gallery). The creation of a particular collection may be initiated by a particular user (e.g., each user for which a record is maintained in the entity table 304). A user may create a “personal story” in the form of a collection of content that has been created and sent/broadcast by that user. To this end, the user interface of the client application 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from varies locations and events. Users whose client devices have location services enabled and are at a common location event at a particular time may, for example, be presented with an option, via a user interface of the client application 104, to contribute content to a particular live story. The live story may be identified to the user by the client application 104, based on his or her location. The end result is a “live story” told from a community perspective.

A further type of content collection is known as a “location story,” which enables a user whose client device 102 is located within a specific geographic location (e.g., on a college or university campus) to contribute to a particular collection. In some examples, a contribution to a location story may require a second degree of authentication to verify that the end user belongs to a specific organization or other entity (e.g., is a student on the university campus).

As mentioned above, the video table 314 stores video data that, in one example, is associated with messages for which records are maintained within the message table 302. Similarly, the image table 316 stores image data associated with messages for which message data is stored in the entity table 304. The entity table 304 may associate various augmentations from the augmentation table 310 with various images and videos stored in the image table 316 and the video table 314.

The database(s) 118 may also store a geographic position data table 318. The geographic position data table 318 may store information indicating geographic positions of a number of users of the client application 104. The information stored in the geographic position data table 318 may be used to determine a relative location of one or more second users of the client application 104 with respect to a location of a first user of the client application 104, where the first user has caused a user locating AR content item to be executed to locate the one or more second users.

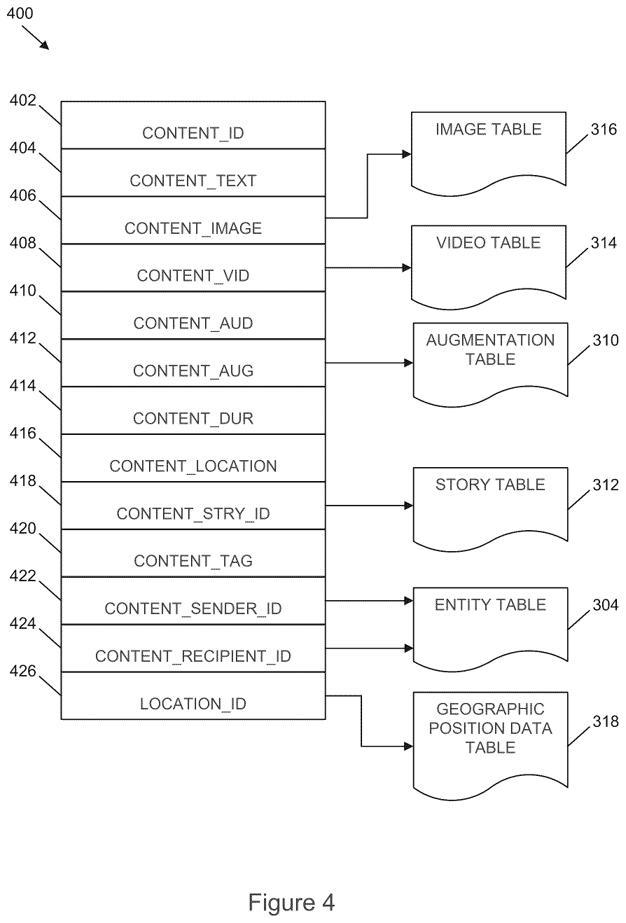

FIG. 4 is a schematic diagram illustrating an example framework for content 400, according to some implementations. The content 400 may be generated by the client application 104. In various examples, the content 400 may be generated by a first instance of the client application 104 and communicated to at least one of a second instance of the client application 104 or the server system 108. In situations where the content 400 includes a message, the content 400 may be used to populate the message table 302 stored within the database(s) 118 and accessible by the application server 114. In one or more implementations, the content 400 may be stored in memory as “in-transit” or “in-flight” data of at least one of client devices 102 or the application server 114. The content 400 is shown to include at least a portion of the following components:
content identifier 402: a unique identifier that identifies the content 400.
content text payload 404: text, to be generated by a user via a user interface of the client device 102, and that is included in the content 400.
content image payload 406: image data, captured by a camera component of a client device 102 or retrieved from a memory component of a client device 102, and that is included in the content 400. Image data for a sent or received content 400 may be stored in the image table 316.
content video payload 408: video data, captured by a camera component or retrieved from a memory component of the client device 102, and that is included in the content 400. Video data for a sent or received content 400 may be stored in the video table 314.
content audio payload 410: audio data, captured by a microphone or retrieved from a memory component of the client device 102, and that is included in the content 400.
content augmentation data 412: augmentation data (e.g., filters, stickers, or other annotations or enhancements) that represents augmentations to be applied to content image payload 406, content video payload 408, or content audio payload 410 of the content 400. Augmentation data for a sent or received content 400 may be stored in the augmentation table 310.
content duration parameter 414: parameter value indicating, in seconds, the amount of time for which one or more portions of the content 400 (e.g., the content image payload 406, content video payload 408, content audio payload 410) are to be presented or made accessible to a user via the client application 104.
content geolocation parameter 416: geolocation data (e.g., latitudinal and longitudinal coordinates) associated with the content payload of the message. Multiple content geolocation parameter 416 values may be included in the payload, each of these parameter values being associated with respect to content items included in the content (e.g., a specific image into within the content image payload 406, or a specific video in the content video payload 408).
content story identifier 418: identifier values identifying one or more content collections (e.g., “stories” identified in the story table 312) with which a particular item in the content image payload 406 of the content 400 is associated. For example, multiple images within the content image payload 406 may each be associated with multiple content collections using identifier values.
content tag 420: each content 400 may be tagged with multiple tags, each of which is indicative of the subject matter of content included in the content payload. For example, where a particular image included in the content image payload 406 depicts an animal (e.g., a lion), a tag value may be included within the content tag 420 that is indicative of the relevant animal. Tag values may be generated manually, based on user input, or may be automatically generated using, for example, image recognition.
content sender identifier 422: an identifier (e.g., a messaging system identifier, email address, or device identifier) indicative of a user of the client device 102 on which the content 400 was generated and from which the content 400 was sent.
content receiver identifier 424: an identifier (e.g., a messaging system identifier, email address, or device identifier) indicative of a user of the client device 102 to which the content 400 is addressed.
location identifier 426: an identifier of a location of a user of the client application 104. The location identifier 426 may include geographic position data of the location of the user. In one or more additional examples, the location identifier 426 may include an identifier of the location of the user, such as a name of a business, a name of an educational entity, a name of a governmental entity, a name of a building, a name of a geological feature, an address, one or more street names, a name of a geographic region, or one or more combinations thereof, and so forth. In various examples, the location identifier 426 may correspond to a location that is related to the content 400. For example, the location identifier 426 may correspond to a location of the user of the client application 104 where the content 400 was captured.

The data (e.g., values) of the various components of content 400 may correspond to pointers to locations in tables within which the data is stored. For example, an image value in the content image payload 406 may be a pointer to (or address of) a location within an image table 316. Similarly, values within the content video payload 408 may point to data stored within a video table 314, values stored within the content augmentations 412 may point to data stored in an augmentation table 310, values stored within the content story identifier 418 may point to data stored in a story table 312, and values stored within the content sender identifier 422 and the content recipient identifier 424 may point to user records stored within an entity table 304. Further, values of the location identifier(s) 426 may point to data stored within a data structure that includes the geographic position data table 318. The location identifier 426 may be used to retrieve information corresponding to additional users of the client application 104 that are located within a geographic region of a first user of the client application 104.

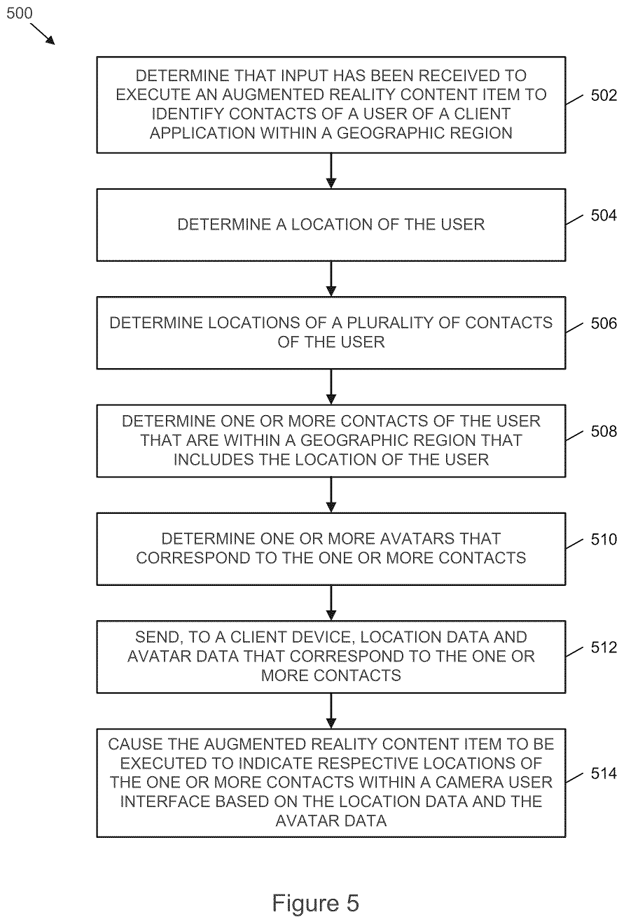

FIG. 5 illustrates a flowchart of processes to show locations of users of a client application within a camera user interface. The processes may be embodied in computer-readable instructions for execution by one or more processors such that the operations of the processes may be performed in part or in whole by the functional components of at least one of the client application 104 or the server system 108. Accordingly, the processes described below are by way of example with reference thereto, in some situations. However, in other implementations, at least some of the operations of the processes described with respect to FIG. 5 may be deployed on various other hardware configurations. The processes described with respect to FIG. 5 are therefore not intended to be limited to the server system 108 or client device 102 and can be implemented in whole, or in part, by one or more additional components. Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

FIG. 5 is a flowchart illustrating example operations of a process 500 to provide augmented reality content to locate users within a camera user interface, in accordance with one or more example implementations. At operation 502, the process 500 may include determining that input has been received to execute an augmented reality content item to identify contacts of a user of a client application within a geographic region. For example, a camera user interface may be displayed in conjunction with an instance of the client application. The camera user interface may display a scene that is captured by at least one camera of a client device of the user. The scene may include a real-time or near real-time view captured by the camera of the client device of the user. The camera user interface may also include one or more user interface elements that are each selectable to execute a respective augmented reality content item. In one or more illustrative examples, the camera user interface may include a user interface element that corresponds to a user locating AR content item. The user interface element that corresponds to the user locating AR content item may be selected via one or more input devices of the client device of the user. In response to determining, that the user interface element corresponding to the user locating AR content item has been selected, the client device may send information, such as a signal or data, to a server system indicating that the user locating AR content item has been executed. Additionally, the client device may send a request for information from the user locating AR content item.

The process 500 may also include, at operation 504, determining a location of the user of the client application and, at operation 506, the process 500 may include determining locations of a plurality of contacts of the user. The location of the user and the locations of the plurality of contacts of the user may correspond to real-time locations or near real-time locations. In one or more scenarios, the location of the user and the contacts of the user may correspond to a current location of the user. The location of the user and the contacts of the user may be determined based on geographic position data obtained from a client device of the user and client devices of the contacts of the user. In one or more additional examples, the location of the user and the contacts of the user may be determined based on geographic position data obtained from one or more network devices. In various examples, the one or more network devices may be included in a wide area wireless communications network. In one or more additional examples, the one or more network devices may be included in at least one of a wireless local area network or a wired local area network. In one or more illustrative examples, the location of the user of the client application and the contacts of the user may be determined based on GPS data obtained from a client device of the user and client devices of the contacts of the user.

The location of the user and the contacts of the user may also be determined by analyzing at least one of image content, text content, one or more objects, one or more contours, or one or more combinations thereof of the user content with respect to at least one of image content or video content of a number of locations. That is, the user content may be analyzed with respect to at least one of one or more images or one or more videos of a location. A measure of similarity between features of the user content and features of at least one of images or videos of a number of locations may be determined. In these scenarios, the location of the user may be determined based on a measure of similarity between features of the user content and features of at least one of images or videos of the location being at least a threshold measure of similarity. In one or more illustrative examples, at least one of one or more object recognition techniques or one or more image analysis techniques may be implemented to determine a measure of similarity between features of the user content and features of at least one of images or videos of a number of locations.

In addition, at operation 508, the process 500 may include determining one or more contacts of the user that are within a geographic region that includes the location of the user. The geographic region may include a geopolitical region, such as at least one of a city, town, village, state, county, territory, province, or country. The geographic region may also include at least one of a neighborhood, one or more buildings, a venue, a landmark, a shopping area, an amusement park, a recreational area, one or more educational buildings, or another location. In various examples, the geographic region may be defined according to a distance from the user, such as from about 0.1 miles to about 0.5 miles, from about 1 mile to about 5 miles, or from about 2 miles to about 10 miles.

At operation 510, the process 500 may include determining one or more avatars that correspond to the one or more contacts. The one or more avatars of the contacts may be a representations of the one or more contacts within the client application. For example, the avatar of a contact may represent the contact in at least one of messages generated using the client application or social networking posts generated using the client application. In one or more additional examples, at least a portion of the avatar of the contact may correspond to a profile image of the contact. In various examples, the avatar of the contact may be generated based on one or more images of the contact. In one or more additional examples, the avatar of the contact may be customized by applying at least one of one or more poses, one or more facial expressions, one or more hair styles, one or more articles of clothing, one or more accessories, one or more objects, or text content to the avatar of the contact. In one or more further examples, the avatar of the contact may be one of a plurality of avatars of the contact. In one or more illustrative examples, the avatar of the contact may correspond to a respective location of the contact. The avatar data may be stored in relation to a profile of the contact with respect to the client application.

Further, at operation 512, the process 500 may include sending, to a client device of the user, location data and avatar data that corresponds to the one or more contacts. The process 500 may also include, at operation 514, causing the augmented reality content item to be executed to indicate respective locations of the one or more contacts within a camera user interface based on the location data and the avatar data. For example, the augmented reality content item may use the location data and the avatar data to display respective avatars of the one or more contacts within the camera user interface based on the relative position of the one or more contacts within the geographic region with respect to the user of the client application. In various examples, the augmented reality content item may also be executable to provide directions to locate at least one contact of the one or more contacts. In one or more examples, the camera user interface includes a user interface element that is selectable to launch an application computing resources that is executable to locate one or more additional users.

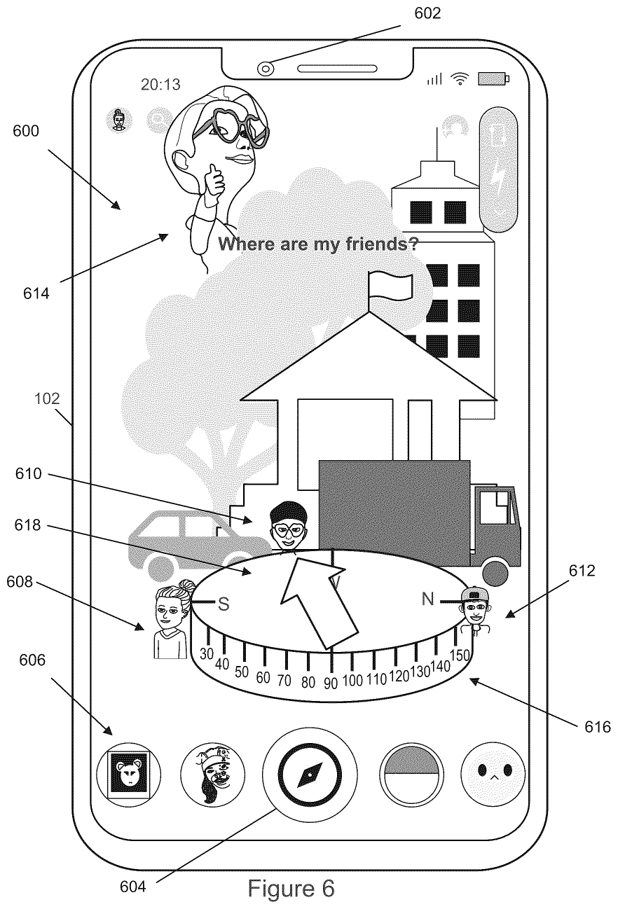

FIG. 6 is an illustration of a first example user interface 600 showing a view of a camera 602 of a client device 102 and showing relative locations of additional users of a client application within a camera user interface, according to one or more example implementations. The user interface 600 may be displayed via a display device of the client device 102. In addition, the user interface 600 may be displayed by a client application, such as the client application 104, that includes at least one of messaging functionality or social networking functionality. In one or more examples, the user interface 600 may include user content that is captured within a field of view of the camera 602. In various examples, the user content may be captured at a location of the user and may include one or more features of the location of the user.

A user locating AR content item user interface element 604 may be one of a plurality of user interface elements 606 included in the user interface 600. In various examples, the plurality of user interface elements 606 may be part of a carousel user interface element that may be used to display a number of user interface elements at a given time. In one or more implementations, the user interface elements included in the carousel user interface element may be modified based on input provided to the client device 102, such as at least one of a swipe left input or a swipe right input. Each of the plurality of user interface elements 606 may be selectable to execute at least one augmented reality content item that is associated with the respective user interface element of the plurality of user interface elements 606. In the illustrative example of FIG. 6, selection of the user locating AR content item user interface element 604 may cause avatars of contacts of the user to be displayed within the user interface 600. For example, a first avatar 608 corresponding to a first contact, a second avatar 610 corresponding to a second contact, and a third avatar 612 corresponding to a third contact may be displayed in the user interface 600. The location of the avatars 608, 610, 612 within the user interface 600 may indicate respective locations of the first contact, the second contact, and the third contact in relation to the location of the user of the client device 102. In the illustrative example of FIG. 6, an enlarged avatar 614 of a contact may be displayed in the user interface 600. In various examples, the position of the enlarged avatar 614 within the user interface 600 may correspond to a location of a contact for which the user of the client device 102 has requested directions to locate. The enlarged avatar 614 may also correspond to a smaller-scale avatar included in the user interface 600. To illustrate, the enlarged avatar 614 may correspond to the same contact as the second avatar 610.

The user interface 600 may also include navigational tools that provide directions to guide a user of the client device 102 to locate one or more contacts. To illustrate, the user interface 600 includes a compass 616. The compass 616 may include an indicator 618 that is pointing to a location of a contact of the user of the client device 102. In various examples, the user of the client device 102 may move in the direction of the indicator 618 to find the contact that corresponds to at least one of the second avatar 610 or the enlarged avatar 614.

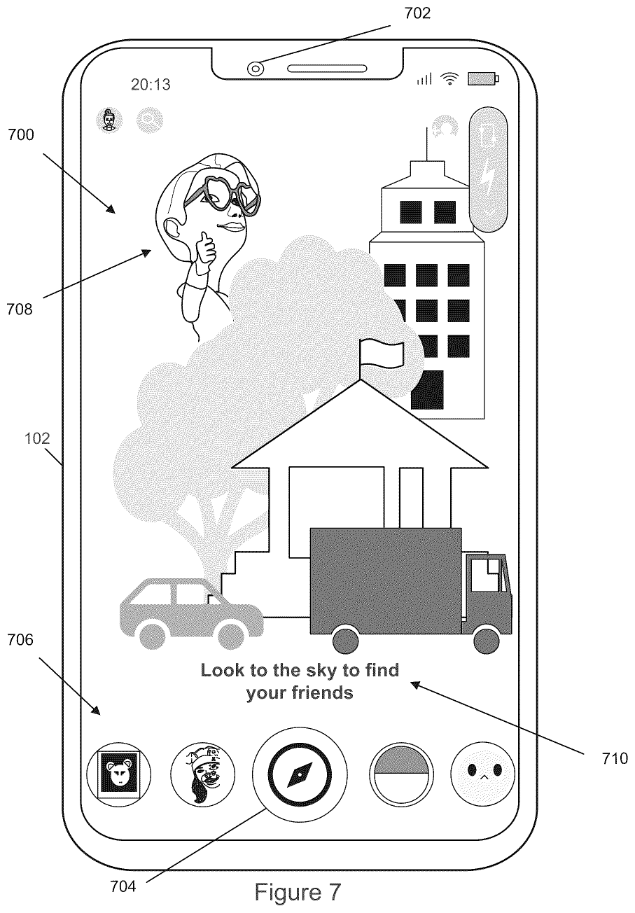

FIG. 7 is an illustration of a second example user interface 700 showing a view of a camera 702 of a client device 102 and showing relative locations of additional users of a client application within a camera user interface, according to one or more example implementations. The user interface 700 may be displayed via a display device of the client device 102. In addition, the user interface 700 may be displayed by a client application, such as the client application 104, that includes at least one of messaging functionality or social networking functionality. In one or more examples, the user interface 700 may include user content that is captured within a field of view of the camera 702. In various examples, the user content may be captured at a location of the user and may include one or more features of the location of the user.

A user locating AR content item user interface element 704 may be one of a plurality of user interface elements 706 included in the user interface 700. In various examples, the plurality of user interface elements 706 may be part of a carousel user interface element that may be used to display a number of user interface elements at a given time. In one or more implementations, the user interface elements included in the carousel user interface element may be modified based on input provided to the client device 102, such as at least one of a swipe left input or a swipe right input. Each of the plurality of user interface elements 706 may be selectable to execute at least one augmented reality content item that is associated with the respective user interface element of the plurality of user interface elements 706. In the illustrative example of FIG. 7, selection of the user locating AR content item user interface element 704 may cause avatars of contacts of the user to be displayed within the user interface 700. For example, an enlarged avatar 708 of a contact may be displayed in the user interface 700. In various examples, the position of the enlarged avatar 708 within the user interface 700 may correspond to a location of a contact for which the user of the client device 102 has requested directions to locate. The user interface 700 may also include text content 710 indicating instructions directed to locating contacts of the user of the client device 102.

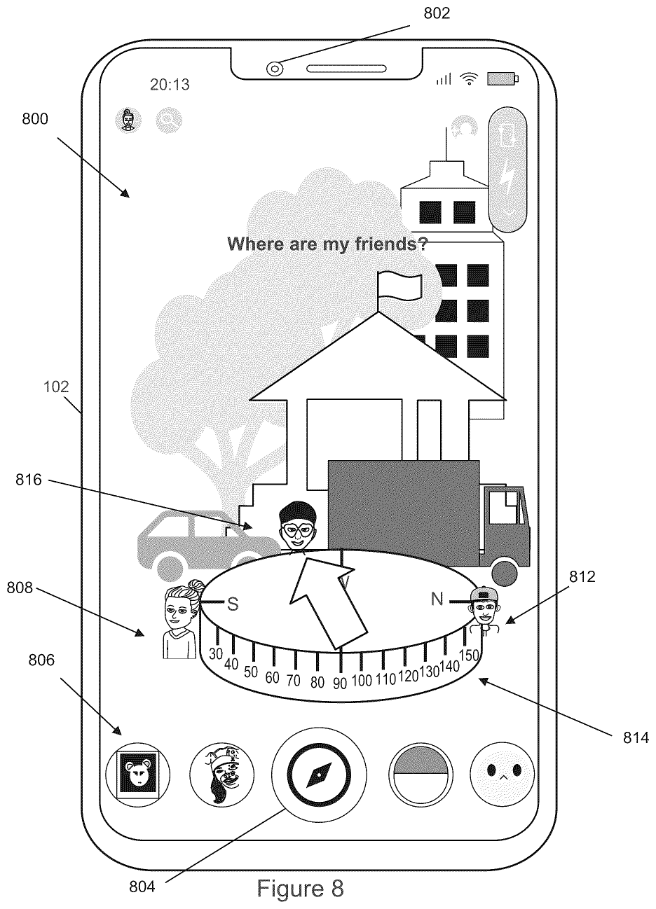

FIG. 8 is an illustration of a third example user interface 800 showing a view of a camera 802 of a client device 102 and showing relative locations of additional users of a client application within a camera user interface, according to one or more example implementations. The user interface 800 may be displayed via a display device of the client device 102. In addition, the user interface 800 may be displayed by a client application, such as the client application 104, that includes at least one of messaging functionality or social networking functionality. In one or more examples, the user interface 800 may include user content that is captured within a field of view of the camera 802. In various examples, the user content may be captured at a location of the user and may include one or more features of the location of the user.

A user locating AR content item user interface element 804 may be one of a plurality of user interface elements 806 included in the user interface 800. In various examples, the plurality of user interface elements 806 may be part of a carousel user interface element that may be used to display a number of user interface elements at a given time. In one or more implementations, the user interface elements included in the carousel user interface element may be modified based on input provided to the client device 102, such as at least one of a swipe left input or a swipe right input. Each of the plurality of user interface elements 806 may be selectable to execute at least one augmented reality content item that is associated with the respective user interface element of the plurality of user interface elements 806. In the illustrative example of FIG. 8, selection of the user locating AR content item user interface element 804 may cause avatars of contacts of the user to be displayed within the user interface 800. For example, a first avatar 808 corresponding to a first contact, a second avatar 810 corresponding to a second contact, and a third avatar 812 corresponding to a third contact may be displayed in the user interface 800. The location of the avatars 808, 810, 812 within the user interface 800 may indicate respective locations of the first contact, the second contact, and the third contact in relation to the location of the user of the client device 102.

The user interface 800 may also include navigational tools that provide directions to guide a user of the client device 102 to locate one or more contacts. To illustrate, the user interface 800 includes a compass 814. The compass 814 may include an indicator 816 that is pointing to a location of a contact of the user of the client device 102. In various examples, the user of the client device 102 may move in the direction of the indicator 816 to find the contact that corresponds the second avatar 810.

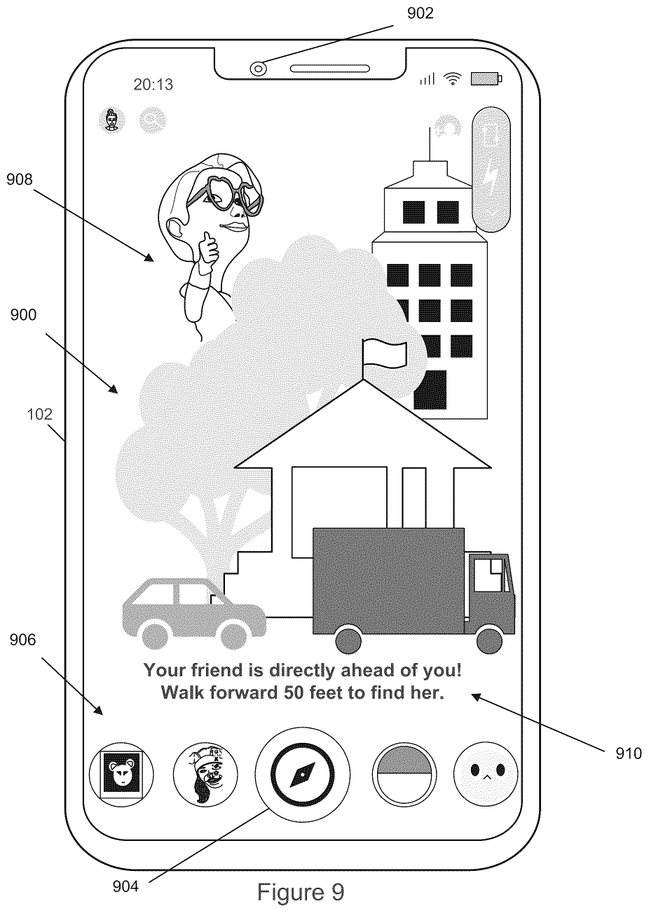

FIG. 9 is an illustration of a fourth user interface 900 showing a view of a camera 902 of a client device 102 and showing relative locations of additional users of a client application within a camera user interface, according to one or more example implementations. The user interface 900 may be displayed via a display device of the client device 102. In addition, the user interface 900 may be displayed by a client application, such as the client application 104, that includes at least one of messaging functionality or social networking functionality. In one or more examples, the user interface 900 may include user content that is captured within a field of view of the camera 902. In various examples, the user content may be captured at a location of the user and may include one or more features of the location of the user.

A user locating AR content item user interface element 904 may be one of a plurality of user interface elements 906 included in the user interface 900. In various examples, the plurality of user interface elements 906 may be part of a carousel user interface element that may be used to display a number of user interface elements at a given time. In one or more implementations, the user interface elements included in the carousel user interface element may be modified based on input provided to the client device 102, such as at least one of a swipe left input or a swipe right input. Each of the plurality of user interface elements 906 may be selectable to execute at least one augmented reality content item that is associated with the respective user interface element of the plurality of user interface elements 906. In the illustrative example of FIG. 9, selection of the user locating AR content item user interface element 904 may cause avatars of contacts of the user to be displayed within the user interface 900. For example, an enlarged avatar 908 of a contact may be displayed in the user interface 900. In various examples, the position of the enlarged avatar 908 within the user interface 900 may correspond to a location of a contact for which the user of the client device 102 has requested directions to locate.

The user interface 900 may also include navigational tools that provide directions to guide a user of the client device 102 to locate one or more contacts. To illustrate, the user interface 900 includes alphanumeric, textual directions to guide a user of the client device 102 to a location of a contact of the user that corresponds to the enlarged avatar 908.

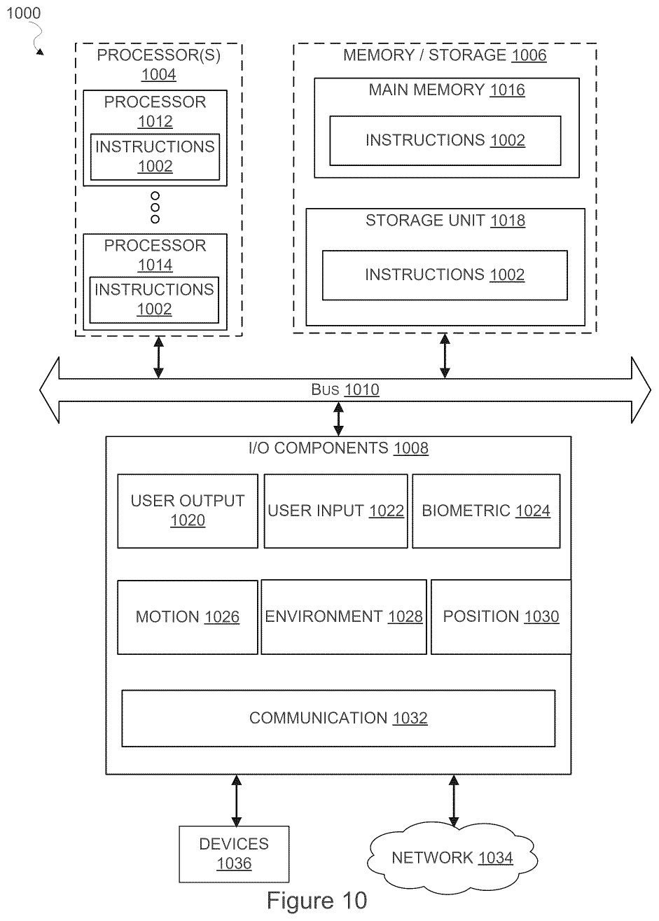

FIG. 10 is a block diagram illustrating components of a machine 1000, according to some example implementations, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1002 (e.g., software, a program, an application, an applet, an app, or other executable code) for causing the machine 1000 to perform any one or more of the methodologies discussed herein may be executed. As such, the instructions 1002 may be used to implement modules or components described herein. The instructions 1002 transform the general, non-programmed machine 1000 into a particular machine 1000 programmed to carry out the described and illustrated functions in the manner described. In alternative implementations, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1002, sequentially or otherwise, that specify actions to be taken by machine 1000. Further, while only a single machine 1000 is illustrated, the term “machine” shall also be taken to include a collection of machines that individually or jointly execute the instructions 1002 to perform any one or more of the methodologies discussed herein.

The machine 1000 may include processors 1004, memory/storage 1006, and I/O components 1008, which may be configured to communicate with each other such as via a bus 1010. In an example implementation, the processors 1004 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1002. The term “processor” is intended to include multi-core processors 1004 that may comprise two or more independent processors (sometimes referred to as “cores”) that may execute instructions 1002 contemporaneously. Although FIG. 10 shows multiple processors 1004, the machine 1000 may include a single processor 1012 with a single core, a single processor 1012 with multiple cores (e.g., a multi-core processor), multiple processors 1012, 1014 with a single core, multiple processors 1012, 1014 with multiple cores, or any combination thereof.

The memory/storage 1006 may include memory, such as a main memory 1016, or other memory storage, and a storage unit 1018, both accessible to the processors 1004 such as via the bus 1010. The storage unit 1018 and main memory 1016 store the instructions 1002 embodying any one or more of the methodologies or functions described herein. The instructions 1002 may also reside, completely or partially, within the main memory 1016, within the storage unit 1018, within at least one of the processors 1004 (e.g., within the processor's cache memory), or any suitable combination thereof, during execution thereof by the machine 1000. Accordingly, the main memory 1016, the storage unit 1018, and the memory of processors 1004 are examples of machine-readable media.

The I/O components 1008 may include a wide variety of components to receive input, provide output, produce output, transmit information, exchange information, capture measurements, and so on. The specific I/O components 1008 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1008 may include many other components that are not shown in FIG. 10. The I/O components 1008 are grouped according to functionality merely for simplifying the following discussion and the grouping is in no way limiting. In various example implementations, the I/O components 1008 may include user output components 1020 and user input components 1022. The user output components 1020 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1022 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example implementations, the I/O components 1008 may include biometric components 1024, motion components 1026, environmental components 1028, or position components 1030 among a wide array of other components. For example, the biometric components 1024 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1026 may include acceleration sensor components (e.g., accelerometer), gravitation sensor components, rotation sensor components (e.g., gyroscope), and so forth. The environmental components 1028 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1030 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 may include communication components 1032 operable to couple the machine 1000 to a network 1034 or devices 1036. For example, the communication components 1032 may include a network interface component or other suitable device to interface with the network 1034. In further examples, communication components 1032 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1036 may be another machine 1000 or any of a wide variety of peripheral devices (e.g., a peripheral device coupled via a USB).

Moreover, the communication components 1032 may detect identifiers or include components operable to detect identifiers. For example, the communication components 1032 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1032, such as location via Internet Protocol (IP) geo-location, location via Wi-Fi® signal triangulation, location via detecting an NFC beacon signal that may indicate a particular location, and so forth.

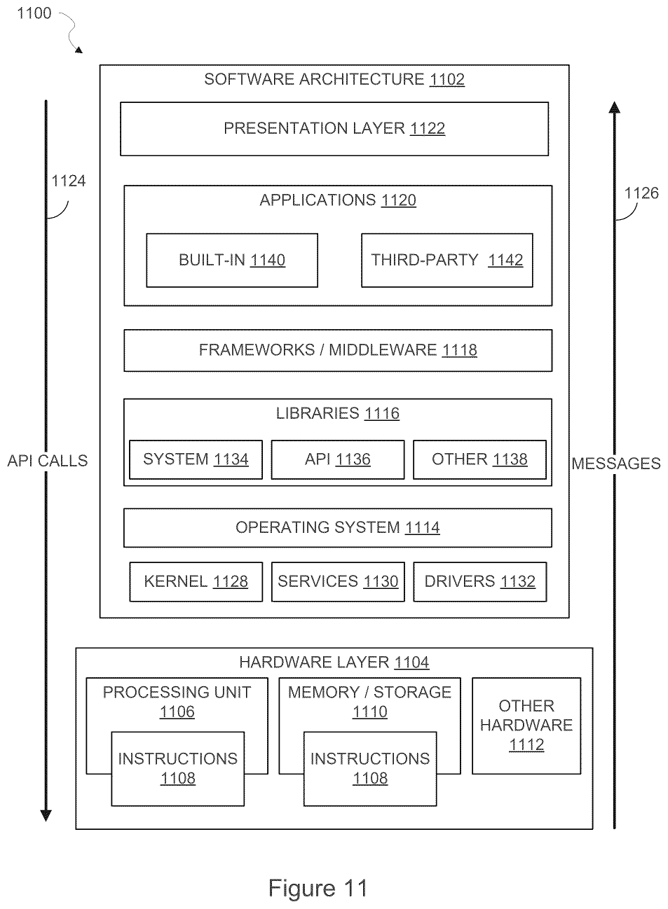

FIG. 11 is a block diagram illustrating system 1100 that includes an example software architecture 1102, which may be used in conjunction with various hardware architectures herein described. FIG. 11 is a non-limiting example of a software architecture and it will be appreciated that many other architectures may be implemented to facilitate the functionality described herein. The software architecture 1102 may execute on hardware such as machine 1000 of FIG. 10 that includes, among other things, processors 1004, memory/storage 1006, and input/output (I/O) components 1008. A representative hardware layer 1104 is illustrated and can represent, for example, the machine 1000 of FIG. 10. The representative hardware layer 1104 includes a processing unit 1106 having associated executable instructions 1108. Executable instructions 1108 represent the executable instructions of the software architecture 1102, including implementation of the methods, components, and so forth described herein. The hardware layer 1104 also includes at least one of memory or storage modules memory/storage 1110, which also have executable instructions 1108. The hardware layer 1104 may also comprise other hardware 1112.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120, and a presentation layer 1122. Operationally, the applications 1120 or other components within the layers may invoke API calls 1124 through the software stack and receive messages 1126 in response to the API calls 1124. The layers illustrated are representative in nature and not all software architectures have all layers. For example, some mobile or special purpose operating systems may not provide a frameworks/middleware 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. The drivers 1132 are responsible for controlling or interfacing with the underlying hardware. For instance, the drivers 1132 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1116 provide a common infrastructure that is used by at least one of the applications 1120, other components, or layers. The libraries 1116 provide functionality that allows other software components to perform tasks in an easier fashion than to interface directly with the underlying operating system 1114 functionality (e.g., kernel 1128, services 1130, drivers 1132). The libraries 1116 may include system libraries 1134 (e.g., C standard library) that may provide functions such as memory allocation functions, string manipulation functions, mathematical functions, and the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks/middleware 1118 (also sometimes referred to as middleware) provide a higher-level common infrastructure that may be used by the applications 1120 or other software components/modules. For example, the frameworks/middleware 1118 may provide various graphical user interface functions, high-level resource management, high-level location services, and so forth. The frameworks/middleware 1118 may provide a broad spectrum of other APIs that may be utilized by the applications 1120 or other software components/modules, some of which may be specific to a particular operating system 1114 or platform.

The applications 1120 include built-in applications 1140 and third-party applications 1142. Examples of representative built-in applications 1140 may include, but are not limited to, a contacts application, a browser application, a book reader application, a location application, a media application, a messaging application, or a game application. Third-party applications 1142 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1142 may invoke the API calls 1124 provided by the mobile operating system (such as operating system 1114) to facilitate functionality described herein.

The applications 1120 may use built-in operating system functions (e.g., kernel 1128, services 1130, drivers 1132), libraries 1116, and frameworks/middleware 1118 to create UIs to interact with users of the system. Alternatively, or additionally, in some systems, interactions with a user may occur through a presentation layer, such as presentation layer 1122. In these systems, the application/component “logic” can be separated from the aspects of the application/component that interact with a user.

### Glossary

“CARRIER SIGNAL,” in this context, refers to any intangible medium that is capable of storing, encoding, or carrying transitory or non-transitory instructions 1002 for execution by the machine 1000, and includes digital or analog communications signals or other intangible medium to facilitate communication of such instructions 1002. Instructions 1002 may be transmitted or received over the network 110, 1034 using a transitory or non-transitory transmission medium via a network interface device and using any one of a number of well-known transfer protocols.
“CLIENT DEVICE,” in this context, refers to any machine 1000 that interfaces to a communications network 110, 1034 to obtain resources from one or more server systems or other client devices 102. A client device 102 may be, but is not limited to, a mobile phone, desktop computer, laptop, PDAs, smart phones, tablets, ultra books, netbooks, laptops, multi-processor systems, microprocessor-based or programmable consumer electronics, game consoles, set-top boxes, or any other communication device that a user may use to access a network 110, 1034.
“COMMUNICATIONS NETWORK,” in this context, refers to one or more portions of a network 110, 1034 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 110, 1034 or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.
“EPHEMERAL MESSAGE,” in this context, refers to a message that is accessible for a time-limited duration. An ephemeral message may be a text, an image, a video, and the like. The access time for the ephemeral message may be set by the message sender. Alternatively, the access time may be a default setting, or a setting specified by the recipient. Regardless of the setting technique, the message is transitory.
“MACHINE-READABLE MEDIUM,” in this context, refers to a component, device, or other tangible media able to store instructions 1002 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)) and/or any suitable combination thereof. The term “machine-readable medium” may be taken to include a single medium or multiple media (e.g., a centralized or distributed database, or associated caches and servers) able to store instructions 1002. The term “machine-readable medium” shall also be taken to include any medium, or combination of multiple media, that is capable of storing instructions 1002 (e.g., code) for execution by a machine 1000, such that the instructions 1002, when executed by one or more processors 1004 of the machine 1000, cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.
“COMPONENT,” in this context, refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an ASIC. A hardware component may also include programmable logic or circuitry that is temporarily configured by software to perform certain operations. For example, a hardware component may include software executed by a general-purpose processor 1004 or other programmable processor. Once configured by such software, hardware components become specific machines (or specific components of a machine 1000) uniquely tailored to perform the configured functions and are no longer general-purpose processors 1004. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering implementations in which hardware components are temporarily configured (e.g., programmed), each of the hardware components need not be configured or instantiated at any one instance in time. For example, where a hardware component comprises a general-purpose processor 1004 configured by software to become a special-purpose processor, the general-purpose processor 1004 may be configured as respectively different special-purpose processors (e.g., comprising different hardware components) at different times. Software accordingly configures a particular processor 1012, 1014 or processors 1004, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In implementations in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices, and can operate on a resource (e.g., a collection of information). The various operations of example methods described herein may be performed, at least partially, by one or more processors 1004 that are temporarily configured (e.g., by software) or permanently configured to perform the relevant operations. Whether temporarily or permanently configured, such processors 1004 may constitute processor-implemented components that operate to perform one or more operations or functions described herein. As used herein, “processor-implemented component” refers to a hardware component implemented using one or more processors 1004. Similarly, the methods described herein may be at least partially processor-implemented, with a particular processor 1012, 1014 or processors 1004 being an example of hardware. For example, at least some of the operations of a method may be performed by one or more processors 1004 or processor-implemented components. Moreover, the one or more processors 1004 may also operate to support performance of the relevant operations in a “cloud computing” environment or as a “software as a service” (SaaS). For example, at least some of the operations may be performed by a group of computers (as examples of machines 1000 including processors 1004), with these operations being accessible via a network 110 (e.g., the Internet) and via one or more appropriate interfaces (e.g., an API). The performance of certain of the operations may be distributed among the processors, not only residing within a single machine 1000, but deployed across a number of machines. In some example implementations, the processors 1004 or processor-implemented components may be located in a single geographic location (e.g., within a home environment, an office environment, or a server farm). In other example implementations, the processors 1004 or processor-implemented components may be distributed across a number of geographic locations.

“PROCESSOR,” in this context, refers to any circuit or virtual circuit (a physical circuit emulated by logic executing on an actual processor 1004) that manipulates data values according to control signals (e.g., “commands,” “op codes,” “machine code,” etc.) and which produces corresponding output signals that are applied to operate a machine 1000. A processor 1004 may, for example, be a CPU, a RISC processor, a CISC processor, a GPU, a DSP, an ASIC, a RFIC or any combination thereof. A processor 1004 may further be a multi-core processor having two or more independent processors 1004 (sometimes referred to as “cores”) that may execute instructions 1002 contemporaneously.

“TIMESTAMP,” in this context, refers to a sequence of characters or encoded information identifying when a certain event occurred, for example giving date and time of day, sometimes accurate to a small fraction of a second.

Changes and modifications may be made to the disclosed implementations without departing from the scope of the present disclosure. These and other changes or modifications are intended to be included within the scope of the present disclosure, as expressed in the following claims.

What is claimed is:

1. A method comprising:
determining, by one or more computing devices comprising one or more processors and memory, that a location of a contact of a user of a client application is within a geographic region in which the user is located;
determining, by the one or more computing devices, an orientation of a client device that is displaying a camera user interface based on a direction that a camera of the client device is facing; and
causing, by the one or more computing devices, the location of the contact to be displayed within the camera user interface in conjunction with an avatar of the contact, wherein the location of the contact is determined based on the orientation of the client device.

2. The method of claim 1, comprising:
causing, by the one or more computing devices, display of a camera user interface within a client application, the camera user interface including a plurality of user interface elements that are individually selectable to launch an augmented reality content item, the plurality of user interface elements being included in a carousel user interface element that causes one or more user interface elements displayed in the carousel user interface element to change in response to user input to the carousel user interface element.

3. The method of claim 2, comprising:
determining, by the one or more computing devices, that input has been received to execute an augmented reality content item to identify contacts of the user of the client application within a geographic region; and
causing, by the one or more computing devices, the augmented reality content item to be executed to indicate individual locations of one or more contacts of the user within the camera user interface of the client application based on location data of the one or more contacts and avatar data of the one or more contacts.

4. The method of claim 3, wherein the input to execute the augmented reality content item indicates selection of a user interface element of the plurality of user interface elements.

5. The method of claim 1, comprising:
determining, by the one or more computing devices, one or more avatars that correspond to the contact; and
obtaining, by the one or more computing devices, avatar data that corresponds to the contact.

6. The method of claim 5, comprising:
determining, by the one or more computing devices, a position of an avatar of the contact of the user within the camera user interface based on the orientation of the client device.

7. The method of claim 1, further comprising:
determining, by the one or more computing devices, that the orientation of the client device has changed from a first orientation to a second orientation; and
determining, by the one or more computing devices, one or more additional contacts of the user that are within the geographic region of the user based on the second orientation of the client device, at least one additional contact of the one or more additional contacts being different from the contact of the user.

8. The method of claim 1, further comprising:
determining, by the one or more computing devices, directions to direct the user of the client application to the location of the contact;
wherein the directions are displayed within the camera user interface.

9. The method of claim 8, further comprising:
determining, by the one or more computing devices, that at least one of an orientation of a client device that is displaying the camera user interface or the location of the user has been changed; and
determining, by the one or more computing devices, modified directions to direct the user of the client device to the contact.

10. A system comprising:
one or more hardware processors; and
one or more non-transitory computer-readable storage media including computer-readable instructions that, when executed by the one or more hardware processors, cause the one or more hardware processors to perform operations comprising:
determining that a location of a contact of a user of a client application is within a geographic region in which the user is located;
determining an orientation of a client device that is displaying a camera user interface based on a direction that a camera of the client device is facing; and
causing the location of the contact to be displayed within the camera user interface in conjunction with an avatar of the contact, wherein the location of the contact is determined based on the orientation of the client device.

11. The system of claim 10, wherein the one or more non-transitory computer-readable storage media include additional computer-readable instructions that, when executed by the one or more hardware processors, cause the one or more hardware processors to perform additional operations comprising:
obtaining a request for directions to locate the contact of the user; and
causing an enlarged avatar of the contact to be displayed in the camera user interface.

12. The system of claim 10, wherein the one or more non-transitory computer-readable storage media include additional computer-readable instructions that, when executed by the one or more hardware processors, cause the one or more hardware processors to perform additional operations comprising:
determining that the user has requested directions to locate the contact of the user within the geographic region in which the user is located; and
causing directions to direct the user of the client application to the location of the contact of the user to be displayed in the camera user interface.

13. The system of claim 10, wherein the one or more non-transitory computer-readable storage media include additional computer-readable instructions that, when executed by the one or more hardware processors, cause the one or more hardware processors to perform additional operations comprising:
analyzing content captured by at least one camera of the client device to determine the geographic region in which the user is located.

14. The system of claim 10, wherein the one or more non-transitory computer-readable storage media include additional computer-readable instructions that, when executed by the one or more hardware processors, cause the one or more hardware processors to perform additional operations comprising:
determining individual locations of a plurality of contacts of the user of the client application;
determining one or more avatars that correspond to the plurality of contacts; and
obtaining location data and avatar data that corresponds to the plurality of contacts.

15. The system of claim 14, wherein the one or more non-transitory computer-readable storage media include additional computer-readable instructions that, when executed by the one or more hardware processors, cause the one or more hardware processors to perform additional operations comprising:
determining that input has been received to execute an augmented reality content item to identify one or more contacts of the plurality of contacts of the user of the client application within the geographic region; and
causing the augmented reality content item to be executed to indicate individual locations of one or more contacts of the user within the camera user interface of the client application based on the location data and the avatar data.

16. The system of claim 14, wherein the one or more non-transitory computer-readable storage media include additional computer-readable instructions that, when executed by the one or more hardware processors, cause the one or more hardware processors to perform additional operations comprising:
determining a position of an avatar of the contact within the camera user interface based on the orientation of the client device.

17. One or more non-transitory computer-readable storage media including instructions that when executed by one or more processors, cause the one or more processors to perform operations comprising:
determining that a location of a contact of a user of a client application is within a geographic region in which the user is located;
determining an orientation of a client device that is displaying a camera user interface based on a direction that a camera of the client device is facing; and
causing the location of the contact to be displayed within the camera user interface in conjunction with an avatar of the contact, wherein the location of the contact is determined based on the orientation of the client device.

18. The one or more non-transitory computer-readable storage media of claim 17, including additional instructions that when executed by one or more processors, cause the one or more processors to perform additional operations comprising:
determining that the orientation of the client device has changed from a first orientation to a second orientation; and
determining one or more additional contacts of the user that are within the geographic region of the user based on the second orientation of the client device, the one or more additional contacts being different from the contact of the user.

19. The one or more non-transitory computer-readable storage media of claim 17, including additional instructions that when executed by one or more processors, cause the one or more processors to perform additional operations comprising:
determining the geographic region in which the user is located based on at least one of geographic positioning system (GPS) data, geographic position data obtained from one or more wide area wireless communication networks, or additional geographic position data obtained from one or more local area networks.

20. The one or more non-transitory computer-readable storage media of claim 17, including additional instructions that when executed by one or more processors, cause the one or more processors to perform additional operations comprising:
causing display of one or more navigational tools within the camera user interface to indicate the location of the contact of the user relative to an additional location of the user.
